(19) United States
(12) Patent Application Publication
(10) Pub. No.: US 2011/0022404 A1
(43) Pub. Date: Jan. 27, 2011

(54) DEVELOPMENT OF TRAVEL PLANS INCLUDING AT LEAST ONE ENVIRONMENTAL IMPACT INDICATION

(75) Inventor: Jeffrey L. Peterson, Elk Grove Village, IL (US)

Correspondence Address: Vedder Price PC, 222 NORTH LASALLE STREET, CHICAGO, IL, 60601, US

(73) Assignee: ACCENTURE GLOBAL SERVICES, GMBH, Schaffhausen (CH)

(21) Appl. No.: 12/507,521

(22) Filed: Jul. 22, 2009

(51) Int. Cl. G06Q 99/00; G01C 21/00; G06Q 50/00

(52) U.S. Cl. 705/1.1; 701/202

(57) ABSTRACT

To assist in the development of travel plans, at least one first and at least one second user input mechanism is provided via a graphical user interface to a user. In response, first travel inputs and second travel inputs are received and respectively used to derive baseline and revised travel parameters, which travel parameters respectively include a baseline and revised environmental impact indication. The baseline and revised travel parameters, including the environmental impact indications, are presented via the graphical user interface. Difference values between the respective baseline and revised travel parameters may be determined and likewise presented. Furthermore, cost and commute time indications may be determined in a similar fashion, i.e., based on the first and second travel inputs, and subsequently presented. The environmental impact indications may be provided in the form of estimated carbon emissions.

### FIELD OF THE INVENTION

The instant disclosure relates generally to travel planning and, in particular, to techniques for developing travel plans that incorporate an environmental impact indication.

### BACKGROUND OF THE INVENTION

The use of computer-based systems when developing travel plans is well known in the art. For example, travel planning services such as “ORBITZ”, “EXPEDIA” and “TRAVELOCITY” provide publicly available websites where a user can research airline flight fares and schedules, hotel availability and costs, rental car availability and costs, etc. Furthermore, tools for assessing the environmental impact of various travel options are available as well. For example, TerraPass Inc. offers a website (currently available at: http://www.terrapass.com/carbon-footprint-calculator/#air) through which a user enters flight origination and destination cities and certain other parameters and is provided with an estimated amount of carbon emissions and the cost to purchase so-called “carbon offsets” in order to mitigate the effect of the user's planned travel. Between these two types of travel planning tools, users are able to research a variety of travel options while being mindful of the environmental impact of their travel arrangements.

While such tools are useful in planning travel, a user planning relatively complex travel arrangements will likely find it difficult to use more than a single site or application, particularly when the user is trying to develop more than one travel itinerary or is attempting to compare different arrangement scenarios. Such a task becomes even more complex, and therefore less likely to employ the benefits of both types of planning tools, when a user is planning for groups of people, potentially originating from or traveling to multiple cities. Further still, not all users wants to buy, or can afford to buy, emissions offsets. However, such users may nevertheless like to be informed of their environmental impact when making travel arrangements.

Thus, techniques that overcome these limitations would represent a welcome advance in the art.

### SUMMARY OF THE INVENTION

The instant disclosure describes various embodiment of methods, apparatus and systems for use in developing travel plans that incorporate at least one environmental impact indication in the context of scenario planning. Thus, in one embodiment, at least one first and at least one second user input mechanism is provided via a graphical user interface to a user. In response to the input mechanisms, first travel inputs and second travel inputs are received and respectively used to derive baseline and revised travel parameters, which travel parameters respectively include an environmental and revised environmental impact indication. The baseline and revised travel parameters, including the environmental impact indications, are presented via the graphical user interface. Difference values between the respective baseline and revised travel parameters may be determined and likewise presented. In further embodiments, cost and commute time indications may be determined in a similar fashion, i.e., based on the first and second travel inputs, and subsequently presented. In one embodiment, the environmental impact indication is in the form a carbon emissions indication.

In this manner, environmental impact considerations are more seamlessly incorporated into travel planning tools than previously available and are therefore more likely to be employed by users.

### BRIEF DESCRIPTION OF THE DRAWINGS

The features described in this disclosure are set forth with particularity in the appended claims. These features and attendant advantages will become apparent from consideration of the following detailed description, taken in conjunction with the accompanying drawings. One or more embodiments are now described, by way of example only, with reference to the accompanying drawings wherein like reference numerals represent like elements and in which:

FIG. 1 is a block diagram of a computer system that may be used to implement the various embodiments described in the instant disclosure;

FIG. 2 is a block diagram illustrating the controller of FIG. 1 in greater detail;

FIG. 3 is a flowchart illustrating processing in accordance with the teachings of the instant disclosure; and

FIGS. 4 and 5 are illustrations of representative graphical user interface screens that may be used in accordance with the instant disclosure.

### DETAILED DESCRIPTION OF THE PRESENT EMBODIMENTS

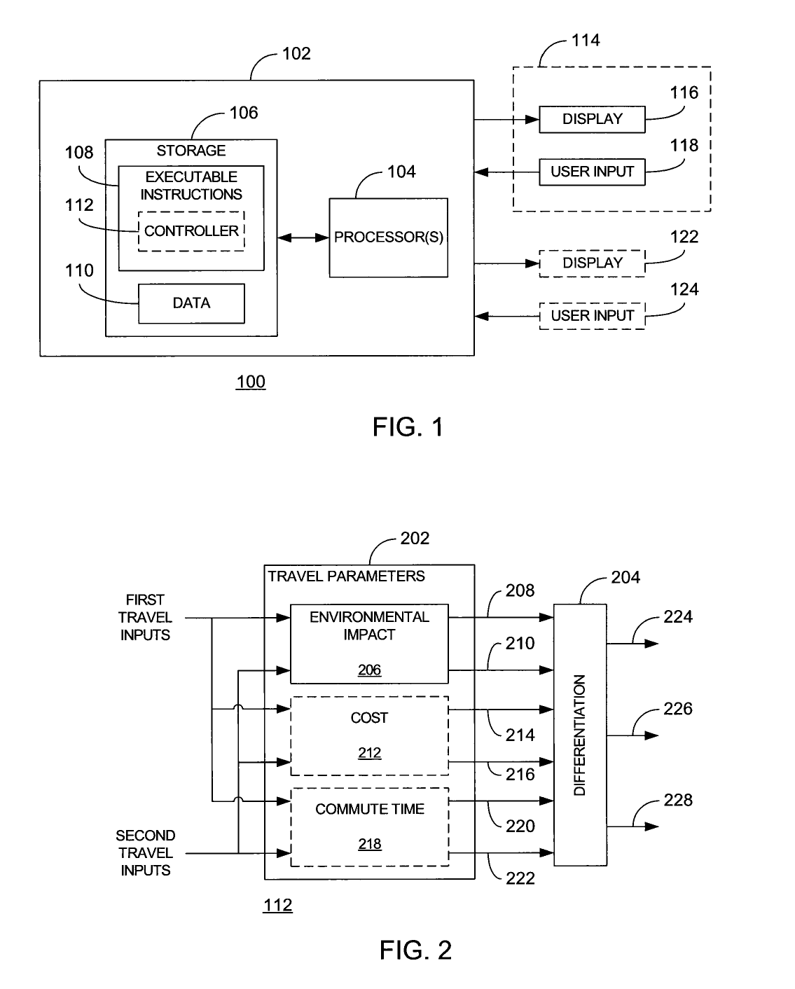

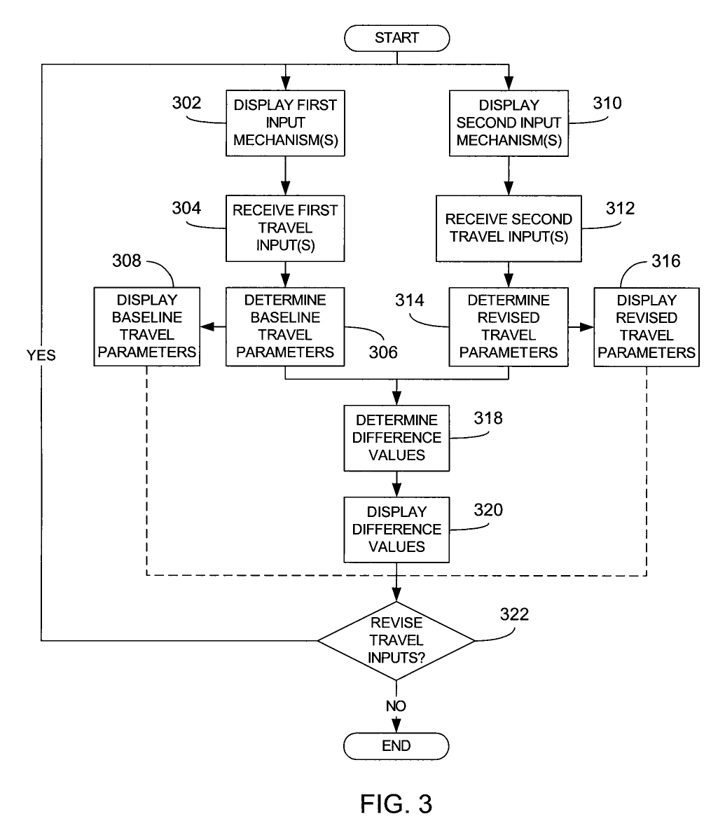

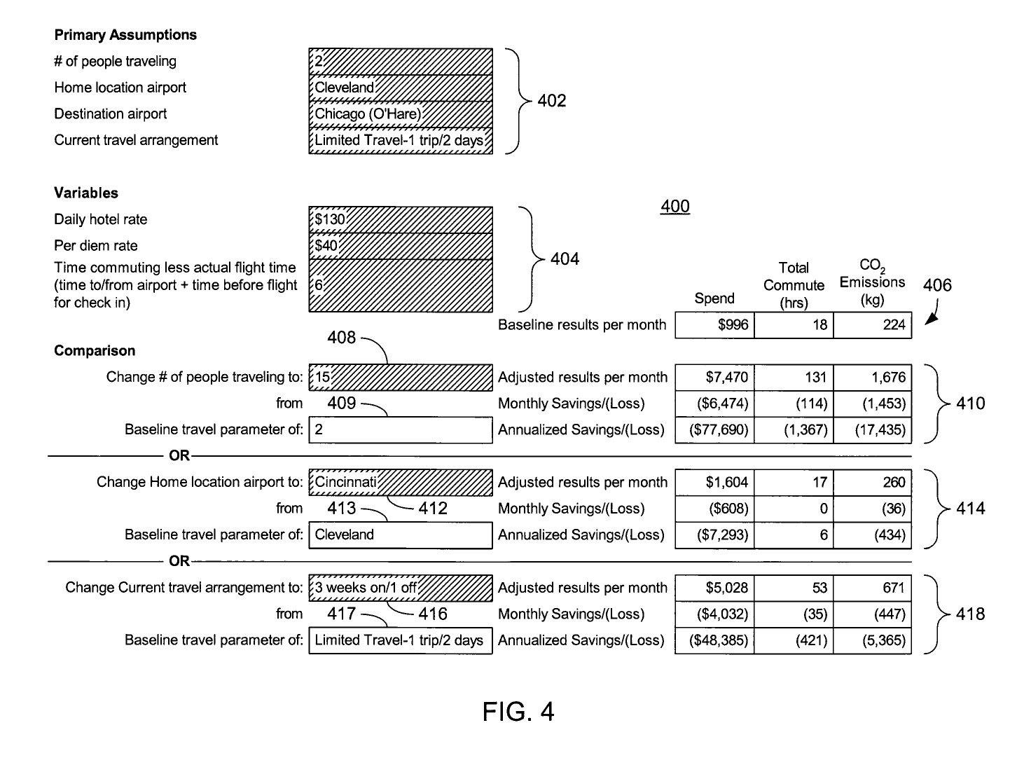

FIG. 1 illustrates a representative computer system 100 that may be used to implement the teachings of the instant disclosure. For example, the system 100 may be used to implement the components illustrated in FIG. 2 and carry out the processing illustrated in FIG. 3. Regardless, as shown, the system 100 comprises a one or more computers 102 that, in turn, each comprise one or more processors 104 coupled to one or more storage components 106. The storage component(s) 106 have stored thereon executable instructions 108 and data 110. In an embodiment, the processor(s) 104 may comprise a microprocessor, microcontroller, digital signal processor, graphics or arithmetic co-processors, etc. or combinations thereof capable of executing the stored instructions 108 and operating upon the stored data 108. The stored data 108 includes the variables, tables, etc., i.e., working data, used during implementation of the techniques described herein. Likewise, the storage component(s) 106 may comprise one or more devices such as volatile or nonvolatile memory including but not limited to random access memory (RAM) or read only memory (ROM). Processor and storage arrangements of the types illustrated in FIG. 1 are well known to those having ordinary skill in the art. As shown in FIG. 1, the executable instructions 108 may implement a controller 112 that, as described in further detail below, implements the processing of user-provided travel inputs to derive the various travel parameters, particularly the environmental impact indications.

As shown, the one or more computers 102 may be operably coupled to a display 116 and one or more user input devices 118. As known in the art, the combination of the display 116 and user input device(s) 118 may be used to implement a graphical use interface whereby data and information may be both provided to and received from a user. The display 116 and user input device(s) 118 may be integral to or peripherally (locally) connected to the one or more computers 102, as in the case, for example, of a laptop or desktop computer having an integral display or display coupled thereto via a video port. Alternatively, the display 116 and user input device(s) 118 may be constituents of a remote computing device 114 (such as a personal computer) operably coupled to the one or more computers 102 via at least one intervening network (not shown), such as a local area network, wireless wide area networks, public networks such as the Internet or World Wide Web, etc. or combinations of such networks well known to those having ordinary skill in the art. In this case, typically, the one or more computers may again be laptop or desktop computers but may also comprise server computers. Further still, as shown, the one or more computers 102 may support interactions with more than one user as indicated by the additional display 122 and user input device(s) 124. In practice, the user input device(s) 118, 124 may comprise any mechanism for providing user input (such as first and second travel inputs, etc. as described below) to the one or more processors 104. For example, the user input device(s) 118, 124 may comprise a keyboard, a mouse, a touch screen, microphone and suitable voice recognition application or any other means whereby a user may provide input data to the processor(s) 104. The display 116, 122 may comprise any conventional display mechanism such as a cathode ray tube (CRT), flat panel display, or any other display mechanism known to those having ordinary skill in the art.

Although not shown in FIG. 1, it is understood that the one or more computers 102 may comprise a variety of other components. For example, one or more peripheral interfaces may include the hardware, firmware and/or software necessary for communication with various peripheral devices, such as media drives (e.g., magnetic disk or optical disk drives), other processing devices or any other input source used in connection with the instant techniques. Likewise, other output devices may optionally comprise similar media drive mechanisms, other processing devices or other output destinations capable of providing information to a user such as speakers, lights, tactile outputs, etc. Finally, a network interface may comprise hardware, firmware and/or software that allows the processor(s) 104 to communicate with other devices via wired or wireless networks, whether local or wide area, private or public, as known in the art.

While the one or more computers 102 have been described as one form for implementing the techniques described herein, those having ordinary skill in the art will appreciate that other, functionally equivalent techniques may be employed. For example, as known in the art, some or all of the executable instruction implemented functionality may be implemented using firmware and/or hardware devices such as application specific integrated circuits (ASICs), programmable logic arrays, state machines, etc. Further still, other implementations may include a greater or lesser number of components than those illustrated. Once again, those of ordinary skill in the art will appreciate the wide number of variations that may be used is this manner.

Referring now to FIG. 2, the controller 112 of FIG. 1 is illustrated in greater detail. In particular, as shown, the controller 112 comprises a travel parameters determination component 202 in operably coupled to a differentiation component 204. In turn, the travel parameters determination component 202 comprises an environmental impact component 206 and, optionally, a cost component 212 and a commute time component 218. As used herein, a component is a discrete, functionally defined entity used to implement a portion of an apparatus, e.g., the controller 112, that may be implemented in accordance with the various teachings described herein, i.e., as instructions executed by a suitable processor, as programmed logic circuits, etc.

As shown, use of the components 206, 212, 218 forming the travel parameters determination component 202 receives as input first and second travel inputs. As described below, the first and second travel inputs are user inputs preferably received via a graphical user interface and specifying desired parameters for travel arrangements needed to perform the processing described herein. For example, and by way of non-limiting example, such travel parameters may include originating and destination airports/cities, a number of people traveling, planned hotel costs, etc. Although the examples illustrated herein specifically refer to air travel, it is understood that the instant teachings may be applied to any other mode of travel. In an embodiment, the first travel inputs pertain to a first or baseline scenario, whereas the second travel inputs pertain to a revised or alternative scenario. By processing travel inputs in this manner, comparison of scenarios is possible, thereby allowing a user to research alternatives to arrive at a desired set of travel arrangements.

The environmental impact component 206 determines respective environmental impact indications based on the first and second travel inputs. For example, in one embodiment, the environmental impact indication is expressed as an estimated number of kilograms of carbon dioxide (CO₂) emissions resulting from the travel arrangements indicated by a given set of travel inputs. Various techniques for computing CO₂ emissions are well known in the art. As an example of a relatively simple technique, in the context of air travel, the distance of the planned flight is compared to a threshold value. If the distance is greater than the threshold, then the distance is multiplied by a first factor used to estimate the kilograms of CO₂ emissions per person; if the distance is less than or equal to the threshold, then the distance is multiplied by a second, larger factor (reflecting the fact that emissions on shorter trips are more influenced by the takeoff and landing phases of a flight, which phases contribute in greater proportion to the emissions) to estimate the kilograms of CO₂ emissions per person. Still other techniques, known to those having skill in the art, may be employed as a matter of design choice. Furthermore, although CO₂ emissions are given as a specific example of the environmental impact indication, it is understood that estimates of other materials having an environmental impact may be equally employed for this purpose, e.g., water vapor, carbon dioxide, methane, nitrous oxide, ozone, chlorofluorocarbons, etc. Regardless of the techniques employed or the specific type of indication provided, the environmental impact component 206 determines an environmental impact indication 208 based on the first travel inputs and a revised environmental impact 210 based on the second travel inputs, which indications 208, 210 are then provided to the differentiation component 204. The differentiation component 204 computes an environmental impact difference value 224 between the environmental impact indication 208 and the revised environmental impact 210.

In a similar manner, the cost component 212 processes the first and second travel inputs to respectively provide a baseline cost indication 214 and a revised cost indication 216. The respective cost indications 214, 216 illustrate the estimated cost for the travel arrangements as specified by the travel inputs. Once again, techniques for estimating a cost indication are well known in the art, a specific example of which is described below. Furthermore, the commute time component 218 processes the first and second travel inputs to respectively provide a baseline commute time indication 220 and a revised commute time indication 222. The respective commute time indications 220, 222 illustrate the estimated amount of commute time required (e.g., getting to/from and waiting in airports) for the travel arrangements as specified by the travel inputs. As described in further detail below, the commute time indications 220, 222 may be determined based on assumptions concerning the average commute time for each person traveling to/from an airport and the average advance check in period for a give flight. As before, both the baseline/revised cost indications 214, 216 and the baseline/revised commute time indications 220, 222 are provided to the differentiation component 204, which computes respective cost difference and commute time difference values 226, 228 by calculating the differences between the baseline and revised cost indications 214, 216 on the one hand, and the baseline and revised commute time indications 220, 222 on the other. Finally, although not illustrated in FIG. 2, the various outputs of the components 204, 206, 212, 218, i.e., the environmental impact indication 208, the revised environmental impact 210, the baseline cost indication 214, the revised cost indication 216, the baseline commute time indication 220, the revised commute time indication 222, the environmental impact difference value 224, the cost difference value 226 and the commute time difference value 228, may be provided to the display(s) 116, 112 via the one or more processors 104.

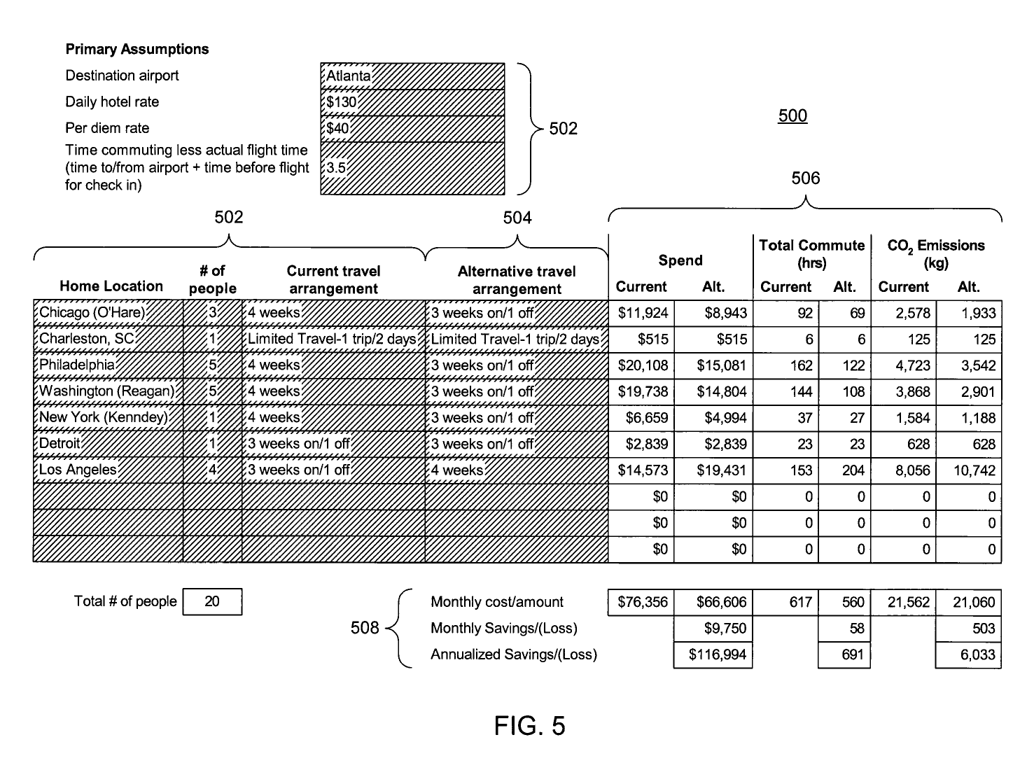

Referring now to FIG. 3, processing in accordance with the instant disclosure is described in further detail, with further reference to FIGS. 4 and 5. As noted above, the processing illustrated in FIG. 3 is preferably implemented by one or more processors executing stored instructions, as in the case of the computer implementation illustrated in FIG. 1, although it is understood that this is not a requirement. Regardless, processing begins at block 302 where at least one first user input mechanism is presented on a display. In an embodiment, the at least one first user input mechanism may comprise any of a number of commonly used graphic user interface input mechanisms, such as one or more text input boxes, combo boxes, drop down lists, radio buttons, sliders, etc. (sometimes referred to as graphical user interface (GUI) widgets). Simultaneously, or subsequently, at block 310, at least one second user input mechanism is presented on the display. Once again, the at least one second user input mechanism may comprise one or more of the above-described GUI widgets. Examples of the output of blocks 302 and 310 are illustrated in FIG. 4.

In particular, FIG. 4 illustrates a graphical user interface 400 comprising a plurality of text boxes 402, 404 corresponding to the at least one first user input mechanism established at block 302. Likewise, further text boxes 408, 412, 416 correspond to the at least one second user input mechanism established at block 310. In the representative graphical user interface 400, the at least one first user input mechanism and the at least one second user input mechanism are displayed simultaneously. In practice, however, this is not a requirement and they could be displayed in a sequential fashion. Regardless, as shown, the at least one first user input mechanism 402 allows a user to input the number of people traveling in a given scenario, the home or originating airport and the destination airport. Also included is a travel arrangement input, which allows the user to quickly describe the recurring nature, if any, of the travel. For example, as shown, the travel arrangement is “Limited Travel” indicating that the travelers will be traveling no more than once a month and staying in hotels for no more than two days per trip. In this manner, as described below, the data necessary to compute the various indications and values described above, can be quickly ascertained. The at least one first user input mechanism 404 permits a user to input assumptions about the daily cost of a hotel, the rate of any per diem to be paid to the travelers and the estimated commuting/waiting time for each traveler.

Processing continues at block 304 where first travel inputs are received via the at least one first user input mechanism. This is illustrated in FIG. 4 by the data values entered into the input text boxes 402, 404. Once again, second travel inputs may be received via the at least one second user input mechanism at substantially the same time as, or subsequent to, the first travel inputs as illustrated by block 312. In the example shown in FIG. 4, the at least one second user input mechanism 408, 412, 416 is provided so as to correspond to single variables corresponding to the at least one first user input mechanism 402, 404. For example, as shown, the input text boxes 408, 412, 416 allow a user to change the input values respectively corresponding to the number of people traveling, the home airport or the type of travel arrangements. For ready comparison, text display boxes 409, 413, 417 display the first travel inputs and are juxtaposed with their corresponding text input boxes 408, 412, 416.

Referring once again to FIG. 3, processing continues at block 306 where the baseline travel parameters are determined based on the first travel inputs received at block 304. Likewise, at block 314, the revised travel parameters are determined based on the second travel inputs received at block 312 either simultaneously with, or subsequent to, the determination made at block 306. Thereafter, at blocks 308 and 316, the baseline travel parameters and the revised travel parameters are presented on the display. Examples of this are illustrated in FIG. 4. Specifically, three different parameters are illustrated as the baseline travel parameters 406, a monthly spend or cost indication, a monthly total commute or commute time indication and a monthly CO₂ emissions or environmental impact indication. In an embodiment, the monthly spend or cost is calculated in terms of US$, the commute time indication is calculated in terms of hours and the environmental impact indication is calculated in terms of kilograms (of emissions) per kilometer traveled (kg/km), although it is understood that other units may be equally employed. In the illustrated embodiment, the cost indication is determined as follows:

$$MonthlyCost = [ \begin{matrix}( A T P * NumTrips ) + \\ ( HotelRate * HotelDays / Month ) + \\ ( PerDiemRate * NumPerDiems )\end{matrix} ] * NumPeople \qquad ( 1 )$$

Where “ATP” is an average ticket price per person for a flight between the originating and destination airports/cities; “NumTrips” is the number of trips per month per person; “HotelRate” is the daily hotel rate per person; “HotelDays/Month” is the number of days each person is to be housed in a hotel; “PerDiemRate” is the daily per diem rate per person; “NumPerDiems” is the number of per diems to be payed per person each month; and “NumPeople” is the total number of people traveling per month under the baseline scenario.

The commute time indication is determined as follows:

MonthlyCommute=[(Time+Commute)*Num Trips]*NumPeople (2)

Where “Time” is the duration of the flight between the originating and destination airports/cities; “Commute” is the average amount of time per person per trip commuting to/from airports and awaiting flights; “NumTrips” is the number of trips per month per person; and “NumPeople” is the total number of people traveling per month under the baseline scenario.

Finally, the environmental impact indication is determined as follows:

MonthlyEI=0.11*Km*NumTrips*NumPeople where Km>1000 km; and

0.15*Km*NumTrips*NumPeople where Km≦1000 km (3)

Where “Km” is the distance of the flight (in kilometers) between the originating and destination airports/cities; “NumTrips” is the number of trips per month per person; and “NumPeople” is the total number of people traveling per month under the baseline scenario. With regard to each of Equations (1)-(3) above, it is again noted that other means for determining these values may be equally employed.

As further shown in FIG. 4, the revised travel parameters are illustrated as the first rows in each of the alternative scenario output blocks 410, 414, 418 and, in this case, are shown as alternative monthly results corresponding to the particular single variable adjusted as part of the second travel inputs 408, 412, 416. Thus, as shown, the revised cost indication, revised commute time indication and the revised environmental impact indication are provided for those alternative scenarios in which the number of people traveling is changed from 2 people to 15 people; the originating location is changed from Cleveland to Cincinnati; or the travel arrangements are changed from “Limited Travel” to “3 weeks on/1 week off”. Note that Equations (1)-(3) are used accordingly when determining the revised travel parameters, with the sole difference being in the particular input values used according to the second travel inputs.

Referring now to block 318, processing continues where difference values between the various baseline and revised travel parameters are determined and, at block 320, subsequently presented on the display. Again, this is illustrated in FIG. 4 where “monthly savings/(loss)” and “annualized savings/(loss)” values are provided relative to each of the alternative scenario output blocks 410, 414, 418. Finally, at block 322, it is determined whether further revisions to the travel inputs are desired. If so, and assuming that the user input mechanisms need to be redisplayed, processing continues at blocks 302 and/or 310. In an alternative embodiment in which the user input mechanisms persist throughout the processing illustrated in FIG. 3, processing may continue at block 304 and/or block 312. In the example illustrated in FIG. 4, this latter embodiment is presumed, and the determination made at block 322 is achieved by simply detecting a change to any of the input text boxes 402, 404, 408, 412, 416.

As described above, the instant disclosure describes techniques for the development of travel plans that simultaneously incorporate scenario comparisons and presentation of one or more environmental impact indications. This is achieved through the provision of a graphical user interface that, in response to multiple sets of travel inputs, presents both baseline and revised travel parameters that include the environmental impact indications. For at least these reasons, the above-described techniques represent an advancement over prior art teachings.

While particular preferred embodiments have been shown and described, those skilled in the art will appreciate that changes and modifications may be made without departing from the instant teachings. For example, as illustrated in FIG. 5, various other embodiments of graphical user interfaces 500 may be employed. In this example, multiple baseline travel inputs may be provided, thereby providing more detailed control over the modeled scenario. Furthermore, alternative scenario is permitted through modification of specific, single variables. Specifically, in addition to the first travel inputs 502, a user is allowed to change a preselected travel input (in this case, the travel arrangement type) to provide the second travel inputs 504. In this case, the various output indications (cost, total commute and environmental impact) are provided for each of the multiple baseline “sub-scenarios” (i.e., each of the illustrated rows) with the current or baseline and alternative or revised results 506 juxtaposed. As before, the monthly and annualized difference values are provided 508. Those having ordinary skill in the art that still further graphical user interfaces may be devised in keeping with the teachings of the instant disclosure. It is therefore contemplated that any and all modifications, variations or equivalents of the above-described teachings fall within the scope of the basic underlying principles disclosed above and claimed herein.

What is claimed is:

1. In a computer system having a graphical user interface comprising a display and a user input device, a method for developing travel plans, the method comprising:
presenting, via the display, at least one first user input mechanism corresponding to a first travel scenario;
receiving, via the user input device and the at least one first user input mechanism, first travel inputs;
determining, by a controller operably coupled to the display and the user input device, baseline travel parameters based on the first travel inputs, the baseline travel parameters comprising an environmental impact indication;
presenting, via the display, the baseline travel parameters;
presenting, via the display, at least one second user input mechanism corresponding to a second travel scenario;
receiving, via the user input device and the at least one second user input mechanism, second travel inputs;
determining, by the controller, revised travel parameters based on the second travel inputs, the revised travel parameters comprising a revised environmental impact indication; and
presenting, via the display, the revised travel parameters.

2. The method of claim 1, further comprising:
determining, by the controller, difference values between the baseline travel parameters and the revised travel parameters; and
presenting, via the display, the difference values.

3. The method of claim 1, wherein the baseline travel parameters comprise at least one of a baseline cost indication and a baseline commute time indication, and wherein the revised travel parameters comprise at least one of a revised cost indication and a revised commute time indication.

4. The method of claim 1, further comprising presenting the at least one second user input mechanism based in part upon the first travel inputs.

5. The method of claim 1, wherein the environmental impact indication comprises a carbon emissions indication determined according to the baseline travel parameters.

6. An apparatus for developing travel plans comprising:
at least one processor;
at least one display operably coupled to the at least one processor;
at least one user input device operably coupled to the at least one processor; and
at least one storage device operably coupled to the at least one processor and having stored thereon instructions that, when executed by the at least one processor, cause the at least one processor to:
present, via the display, at least one first user input mechanism corresponding to a first travel scenario;
receive, via the user input device and the at least one first user input mechanism, first travel inputs;
determine baseline travel parameters based on the first travel inputs, the baseline travel parameters comprising an environmental impact indication;
present, via the display, the baseline travel parameters;
present, via the display, at least one second user input mechanism corresponding to a second travel scenario;
receive, via the user input device and the at least one second user input mechanism, second travel inputs;
determine revised travel parameters based on the second travel inputs, the revised travel parameters comprising a revised environmental impact indication; and
present, via the display, the revised travel parameters.

7. The apparatus of claim 6, the at least one storage device further comprising instructions that, when executed by the at least one processor, cause the at least one processor to:
determine difference values between the baseline travel parameters and the revised travel parameters; and
present, via the display, the difference values.

8. The apparatus of claim 6, wherein the instructions that, when executed by the at least one processor, cause the at least one processor to determine the baseline travel parameters are further adapted to determine at least one of a baseline cost indication and a baseline commute time indication.

9. The apparatus of claim 6, wherein the instructions that, when executed by the at least one processor, cause the at least one processor to determine the revised travel parameters are further adapted to determine at least one of a revised cost indication and a revised commute time indication.

10. The apparatus of claim 6, wherein the instructions that, when executed by the at least one processor, cause the at least one processor to present the at least one second user input mechanism are further adapted to present the at least one second user input mechanism based in part upon the first travel inputs.

11. The apparatus of claim 6, wherein the instructions that, when executed by the at least one processor, cause the at least one processor to determine the environmental impact indication are further adapted to determine a carbon emissions indication according to the baseline travel parameters.

12. An apparatus for developing travel plans comprising:
an environmental impact component adapted to receive first travel inputs and determine an environmental impact indication based on the first travel inputs, and further adapted to receive second travel inputs and determine a revised environmental impact indication based on the second travel inputs;
a differentiation component, operably coupled to the environmental impact component, adapted to receive the environmental impact indication and the revised environmental impact indication and determine an environmental impact difference value based thereon; and
a display, operably coupled to the environmental impact component and the differentiation component and adapted to display at least one of the environmental impact indication, the revised environmental impact indication and the environmental impact difference value.

13. The apparatus of claim 12, further comprising:
a cost component adapted to receive the first travel inputs and determine a baseline cost indication based on the first travel inputs, and further adapted to receive the second travel inputs and determine a revised cost indication based on the second travel inputs,
wherein the differentiation component is operably coupled to the cost component and further adapted to receive the baseline cost indication and the revised cost indication and determine a cost difference value based thereon,
and wherein the display is adapted to display the cost difference value.

14. The apparatus of claim 12, further comprising:
a commute time component adapted to receive the first travel inputs and determine a baseline commute time indication based on the first travel inputs, and further adapted to receive the second travel inputs and determine a revised commute time indication based on the second travel inputs,
wherein the differentiation component is operably coupled to the commute time component and further adapted to receive the baseline commute time indication and the revised commute time indication and determine a commute time difference value based thereon,
and wherein the display is adapted to display the commute time difference value.
